(19) United States
(12) Patent Application Publication
(10) Pub. No.: US 2008/0128202 A1
(43) Pub. Date: Jun. 5, 2008

(54) Composite Panel with Reinforced Recesses

(75) Inventors: Daniel L. Palumbo, Newport News, VA (US); Jacob Klos, Newport News, VA (US); Ferdinand W. Grosveld, Hampton, VA (US); William D. Castle, Yorktown, VA (US)

Correspondence Address: NATIONAL AERONAUTICS AND SPACE ADMINISTRATION;LANGLEY RESEARCH CENTER, MAIL STOP 141, HAMPTON, VA, 23681-2199, US

(73) Assignee: U.S.A . as represented by the Administrator of the National Aeronautics ans Space Administration, Washington, DC (US)

(21) Appl. No.: 11/946,207

(22) Filed: Nov. 28, 2007

Related U.S. Application Data
(63) Continuation-in-part of application No. 11/129,755, filed on May 13, 2005.
(60) Provisional application No. 60/867,466, filed on Nov. 28, 2006.

(51) Int. Cl. B32B 3/12; B32B 3/00; E04B 1/82

(52) U.S. Cl. 181/292; 428/172; 428/116; 181/290

(57) ABSTRACT

A composite panel has one or more recesses, or smoothly-contoured recesses formed in one or both opposing sides of a core. Reinforcement conforming to each recess is coupled to the core at the recess. First and second facing sheets are respectively coupled to the first and second opposing sides of the core.

### ORIGIN OF THE INVENTION

The invention described herein was made by employees of the United States Government and may be manufactured and used by or for the Government for governmental purposes without the payment of any royalties thereon or therefor. This is a continuation-in-part of co-pending application Ser. No. 11/129,755, filed May 13, 2005. Pursuant to 35 U.S.C. §120, the benefit of priority from co-pending application Ser. No. 11/129,755, is claimed, and further pursuant to 35 U.S.C. §119, the benefit of priority from provisional application 60/867,466, with a filing date of Nov. 28, 2006, is claimed for this non-provisional application.

### CROSS-REFERENCE TO RELATED PATENT APPLICATIONS

This patent application is co-pending with one related patent application entitled “COMPOSITE PANEL HAVING SUBSONIC TRANSVERSE WAVE SPEED CHARACTERISTICS”, U.S. Patent Publication No. 2006/0272279, owned by the same assignee as this patent application.

### BACKGROUND OF THE INVENTION

1. Field of the Invention

This invention relates to composite panels. More specifically, the invention is a composite panel that uses reinforced recesses to simultaneously achieve good strength, low weight and low noise transmission.

2. Description of the Related Art

Composite materials are used in many construction applications (e.g., structures, aircraft, trains, vehicles, industrial machines, etc.) because of their light weight and strength. The materials are frequently formed into what are known as composite panels where two sheets of one or two types of materials are sandwiched about another type of core material. For example, one type of composite panel has two sheets of a material such as graphite-epoxy, para-aramid synthetic fiber epoxy (Kevlar), fiberglass or aluminum, or a combination thereof, sandwiched about a honeycomb core made from materials such as meta-aramid fiber (NOMEX), aluminum or paper. The resulting composite panel is light, and stiffer than any of its component parts. However, as can be the case with most lightweight and stiff materials, sound can be radiated very efficiently because the transverse wave speed through the panel can be greater than the speed of sound in air. In other words, the composite panel has a supersonic transverse wave speed. If the composite panel is to be used to define an—interior space, noise radiated by the composite panel into the interior space may be unacceptable. Current methods of addressing this noise problem have involved the addition of damping material or noise control material to the composite panel such that the noise-controlled composite panel is characterized by a subsonic transverse wave speed. Suggested additions include a limp mass (e.g., lead vinyl) or visco-elastic layer applied to one or both of the composite panel's face sheets and/or the inclusion of foam within the composite panel's core in the case of a honeycomb core. However, the extra noise-control material adds cost and weight to the composite panel.

### SUMMARY OF THE INVENTION

Accordingly, it is an object of the present invention to provide a composite panel capable of low noise transmission while also possessing good strength and low weight characteristics needed, for example, in load-carrying applications.

In accordance with at least one embodiment of the present invention, a composite panel has a core with one or more recesses, or smoothly-contoured recesses formed in the core on at least one of first and second opposing sides thereof. Reinforcement conforming to some or each of the smoothly-contoured recesses is coupled to the core at the recesses. As a result, reduced-sized recesses are defined by the reinforcement. First and second facing sheets are respectively coupled to the first and second opposing sides of the core.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is an exploded perspective view of a composite panel having a core with recessed regions in accordance with an embodiment of the present invention;

FIG. 2 is a cross-sectional view of the composite panel of FIG. 1 in its assembled form;

FIG. 3 is a cross-sectional view of a composite panel in accordance with another embodiment of the present invention where the recesses are different sizes;

FIG. 4 is a cross-sectional view of a composite panel in accordance with another embodiment of the present invention where the recesses are formed on either side of the core in a mirror-image fashion;

FIG. 5 is a cross-sectional view of a composite panel in accordance with another embodiment of the present invention where the recesses are formed on either side of the core in a non-mirror-image fashion;

FIG. 6 is a cross-sectional view of a composite panel in accordance with another embodiment of the present invention where areas of non-attachment are provided between the core and face sheets;

FIG. 7 is a cross-sectional view of the composite panel of FIG. 2 further having acoustically absorbent or vibration damping material, or a combination thereof, material in the panel's recesses;

FIG. 8 is a cross-sectional view of a composite panel in accordance with another embodiment of the present invention where recesses are formed in one of the face sheets;

FIG. 9 is a cross-sectional view of a composite panel in accordance with another embodiment of the present invention where smoothly-contoured recesses formed in the panel's core have reinforcing sheets conforming and bonded thereto;

FIG. 10 is a cross-sectional view of a composite panel in accordance with another embodiment of the present invention where the smoothly-contoured recesses formed in the panel's core have reinforcing sheets conforming and bonded thereto with vibration damping material or acoustically absorbent material, or a combination thereof, disposed between the reinforcing sheets and the panel's face sheet;

FIG. 11 is a cross-sectional view of a composite panel in accordance with another embodiment of the present invention where the smoothly-contoured recesses formed in the panel's core have a dimpled reinforcing face sheet bonded to the core with the dimples, convex portions conforming to the recesses; and

FIG. 12 is a cross-sectional view of a composite panel in accordance with another embodiment of the present invention where the smoothly-contoured recesses formed in the panel's core have a dimpled reinforcing face sheet bonded to the core with the dimples' convex portions conforming to the recesses and concave portions having vibration damping material disposed therein.

### DETAILED DESCRIPTION OF THE INVENTION

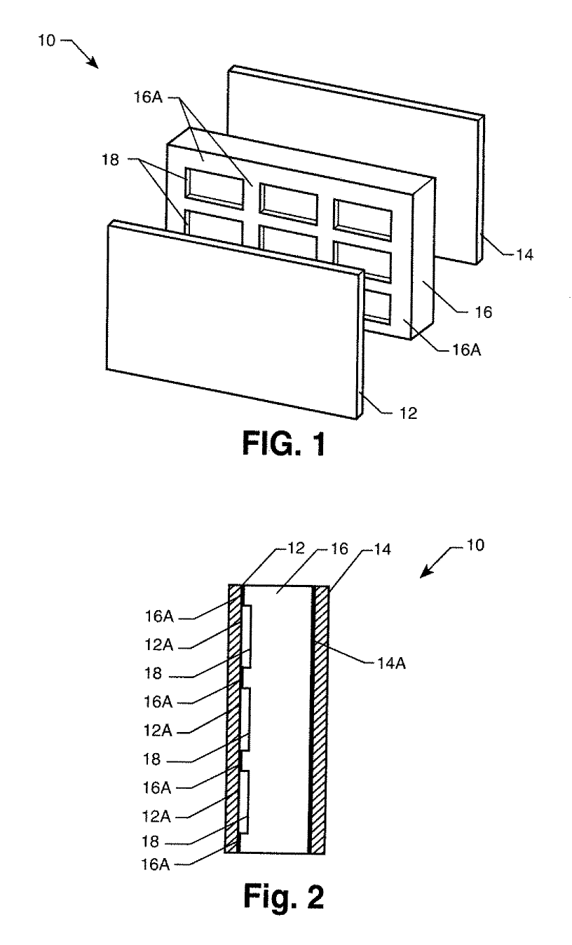

Referring now to the drawings, and more particularly to FIGS. 1 and 2, a composite panel in accordance with an embodiment of the present invention is shown and is referenced generally by numeral 10. For illustration, composite panel 10 is a flat panel. However it is to be understood that composite panels constructed in accordance with the present invention can also be shaped to define contoured panels as needed.

Composite panel 10 has face sheets 12 and 14 sandwiched about a core 16. Face sheets 12 and 14 can be the same or different materials. Suitable materials for face sheets 12 and 14 include, but are not limited to, graphite epoxy, aluminum and fiberglass. Core 16 is a lightweight material that is bonded, attached or adhered (in ways well understood in the art) to face sheets 12 and 14 to form composite panel 10 such that the stiffness of composite panel 10 is greater than the stiffness of it's component parts. As a result, while the transverse wave speed for typical materials and thicknesses of face sheets 12 and 14 is subsonic, the transverse wave speed is very often supersonic for a composite panel using these face sheets. Suitable constructions for core 16 include, but are not limited to, a honeycomb structure, a truss structure, or a foam structure. Suitable materials for core 16 include, but are not limited to, meta-aramid fiber (NOMEX), paper and aluminum in the case of honeycomb cores, and polymers and carbon in the case of foam cores. The core can be of varying thicknesses depending, for example, on a particular application, without departing from the scope of the present invention.

One embodiment of the present invention addresses this problem by forming recesses in core 16 adjacent face sheet 12. More specifically, an array of recesses 18 are formed in core 16 so that face sheet 12 is only bonded/attached/adhered to core 16 at regions 16A while the entire side of face sheet 14 is bonded/attached/adhered to the other side of core 16 as indicated by 14A. The number, size, depth and shape of recesses 18 and resulting size/shape of regions 16A can vary without departing from the scope of the present invention. In general, a balance must be struck between stiffness requirements and noise requirements of composite panel 10. With respect to noise reduction, the greater the area of the recesses, the greater the reduction in sound radiation efficiency and increase in sound power transmission loss. This is because each region 12A of face sheet 12 adjacent to a recess 18 is uncoupled from core 16 so that transverse wave speed at this local region of composite panel 10 is reduced to the subsonic transverse wave speed of face sheet 12. With respect to stiffness, composite panel 10 must have sufficient attachment regions 16A (between face sheet 12 and core 16) to achieve the necessary stiffness requirements. Accordingly, any given application of the present invention will require these two criteria to be balanced.

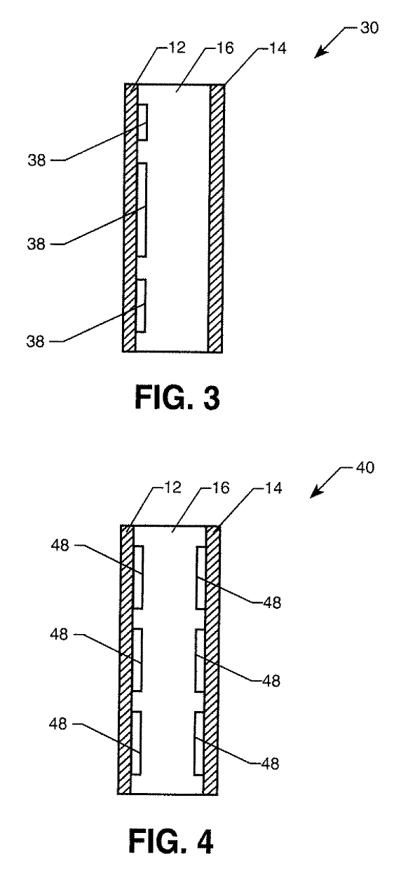

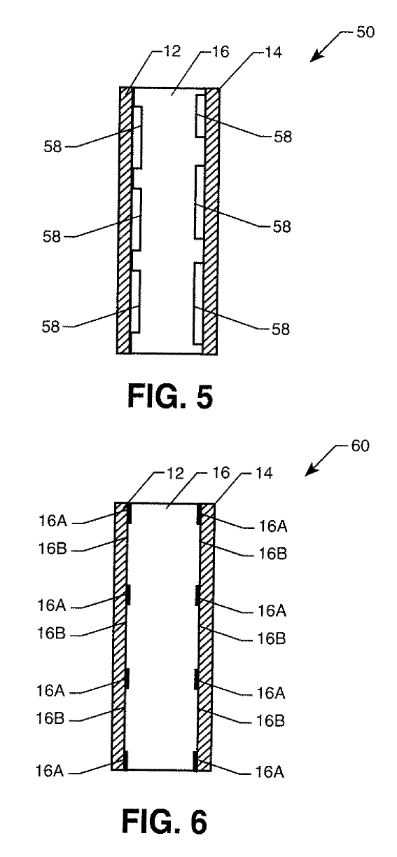

In the illustrated embodiment discussed thus far, identically-sized recesses 18 are formed just on one side of core 16. However, the present invention is not so limited. For example, composite panel 30 in FIG. 3 has recesses 38 formed in core 16 that are of different sizes. Note that the shapes of recesses 38 could vary too. In FIG. 4, composite panel 40 has recesses 48 formed on either side of core 16 in a mirror-image fashion so that the regions of face sheets 12 and 14 contacting and attached to core 16 are similarly mirror images of one another. Composite panel 50 in FIG. 5 utilizes recesses 58 on opposing sides of core 16, but in a non-mirror-image fashion.

Another embodiment of the present invention is illustrated by a composite panel 60 in FIG. 6 where, rather than forming recesses in core 16, regions of non-attachment 16B are formed between face sheets 12/14 and core 16. That is, face sheets 12 and 14 are coupled to core 16 only at attachment regions 16A while remaining uncoupled or unattached to core 16 at non-attached regions 16B. As sound radiates through composite panel 60, friction losses will be generated between the non-attached regions 16B of core 16 and face sheets 12 and 14. In many applications, this will be sufficient to produce a satisfactory low frequency response. However, higher-frequency buzzing may occur thereby making this embodiment most suitable for applications where high-frequency buzzing is not problematic.

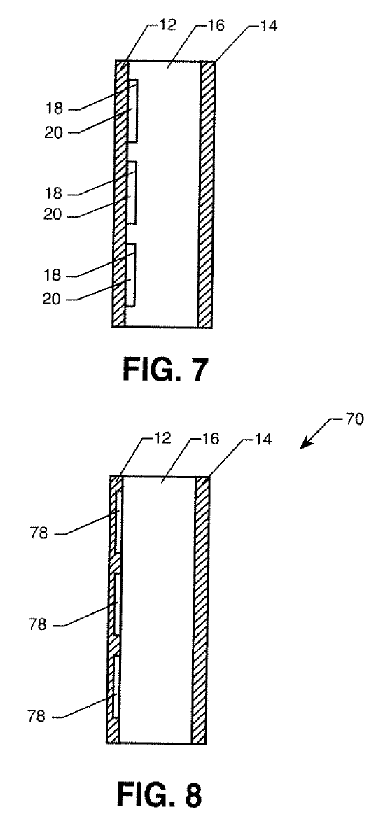

Still another embodiment of the present invention involves adding an acoustically absorbent material (a wide variety of which are well known in the art) to some or all of the recesses formed in the composite panel's core. For example, FIG. 7 illustrates the FIG. 2 embodiment with recesses 18 further having an acoustically absorbent material 20 partially or completely filling recesses 18. Additionally, for applications that would subject a composite panel to load-induced vibrations resulting in panel-generated noise, acoustic and/or vibration damping material can be disposed partially or fully in some or all of the recesses formed in the composite panel's core. For example, this material could be disposed in recesses 18 as illustrated in FIG. 7 (e.g., absorbent material 20), or in the recesses 78 illustrated in FIG. 8. The choice of damping material 20 is not a limitation of the present invention and can be selected for a particular application. Suitable materials can include fiberglass, acoustic foam, viscous materials, or any other vibration damping material that can achieve the desired acoustic and/or vibration damping for a particular application. For example, when only acoustic damping is required, fiberglass may be used. However, a foam or viscoelastic material may be the better material choice when vibrations are of concern. Material(s) can also be selected based on their combined acoustic and vibration damping properties. Additionally, in another embodiment of the present invention as depicted in FIG. 6, to reduce vibrations, a viscoelastic material could also be utilized between the non-attached regions 16B of core 16 and face sheets 12 and 14.

The present invention is not limited to the formation of recesses in the core of a composite panel. For example, a composite panel 70 illustrated in FIG. 8 has recesses 78 formed in face sheet 12. Although not illustrated, recesses could also be formed in face sheet 14 in a mirror-image or non-mirror-image fashion with respect to recesses 78. Still further, recesses could be formed in one or both of face sheets 12/14 and in core 16 without departing from the scope of the present invention.

For applications requiring greater panel stiffness (e.g., floors, aircraft parts, aerospace structures, etc.), the recessed areas of the core can be reinforced in a way that stiffens the panel while substantially maintaining the present invention's low-noise transmission qualities. By way of non-limiting examples, several core recess reinforcement constructions will be presented herein where core recesses are only illustrated on one side of the core. However, it is to be understood that core recesses can be provided on both opposing sides of the core in a mirror or non-mirror image fashion as described above for previous embodiments of the present invention. Further, the core recesses are illustrated as being identical in size for ease of illustration, but could be different sizes without departing from the scope of the present invention.

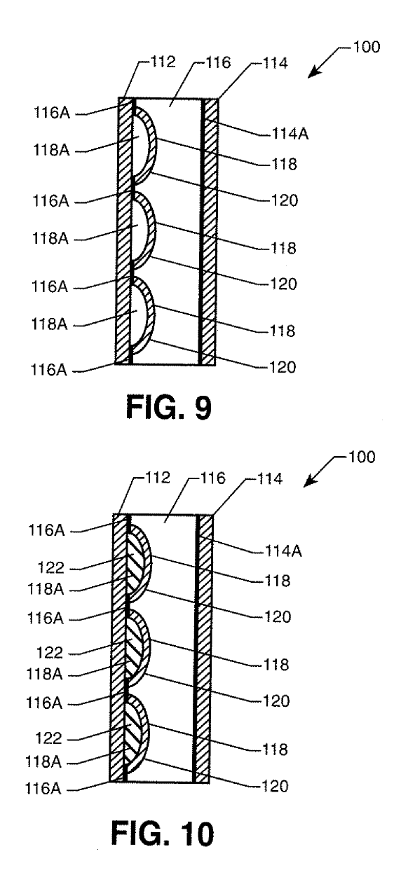

Referring first to FIG. 9, a composite panel 100 has face sheets 112 and 114 sandwiched about a core 116. Face sheets 112 and 114 can be the same or different materials. Suitable materials for face sheets 112 and 114 include, but are not limited to, graphite epoxy, aluminum and fiberglass. In general, core 116 is a lightweight material that is bonded, attached or adhered to face sheets 112 and 114 to form composite panel 100 such that the stiffness of composite panel 100 is greater than the stiffness of it's component parts. As in the previous embodiments, the transverse wave speed for typical materials and thicknesses of face sheets 112 and 114 is subsonic, while the transverse wave speed is very often supersonic for a composite panel using these face sheets. For many load-carrying applications, core 116 will be a honeycomb structure. Suitable materials for a honeycomb core include, but are not limited to, meta-aramid fiber (NOMEX), paper and aluminum. The core can also be of varying thickness without departing from the scope of the present invention.

In FIG. 9, recesses 118 are formed in one side of core 116 adjacent face sheet 112. More specifically, recesses 118 are one or more recesses, or smoothly-contoured recesses to minimize stresses in core 116. By way of non-limiting example, recesses 118 can be simple semi-spherical depressions formed or cut in one surface of core 116 (as shown), or in both opposing surfaces of core 116. Thus, face sheet 112 is only bonded/attached/adhered to core 116 at surface regions 116A between recesses 118. In this embodiment where no recesses are formed on the opposing side of core 116 adjacent to face sheet 114, the entire side of face sheet 114 is bonded/attached/adhered to the other side of core 116 as indicated by 114A. The number, size, depth and shape of recesses 118 and resulting size/shape of surface regions 116A can vary without departing from the scope of the present invention.

As shown, each of recesses 118 is reinforced by the inclusion of a conforming sheet 120 that fits in and conforms to a corresponding one of recesses 118. Each reinforcement sheet 120 is a conforming sheet of a stiff material (e.g., aluminum, graphite epoxy, fiberglass, etc.) that can be bonded to core 116 at recesses 118. As a result, composite panel 100 has slightly smaller-sized recesses 118A defined between reinforcement sheets 120 and face sheet 112. Thus, composite panel 100 achieves increased noise reduction via the presence of recesses 118A, but also has increased stiffness/strength as the core's recesses 118 are reinforced with conforming reinforcing sheets 120. Reinforcing sheets can also be bonded on the edges thereof to face sheet 112. Such bonding may be especially useful when composite panel 100 is a shaped or contoured panel.

For applications that would subject composite panel 100 to load-induced vibrations resulting in panel-generated noise, acoustic and/or vibration damping material 122 can be disposed partially or fully in recesses 118A (i.e., between reinforcing sheets 120 and face sheet 112) as illustrated in FIG. 10. The choice of damping material 122 is not a limitation of the present invention and can be selected for a particular application. Suitable materials can include fiberglass, acoustic foam, viscous materials, or any other vibration damping material that can achieve the desired acoustic and/or vibration damping for a particular application. For example, when only acoustic damping is required, fiberglass may be used. However, a foam or viscoelastic material may be the better material choice when vibrations are of concern. Material(s) can also be selected based on their combined acoustic and vibration damping properties.

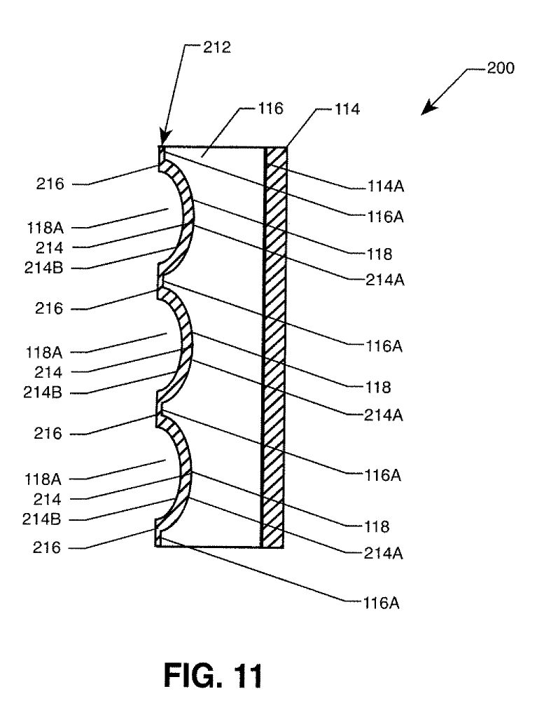

Recess reinforcement in the present invention can also be achieved by integrating the recess reinforcement with the composite panel's face sheet. An example of this construction is illustrated in FIG. 11 where composite panel 200 includes core 116 with face sheet 114 attached to one side thereof as in the previous embodiments. Smoothly-contoured recesses 118 are similarly formed in the other side of core 116. However, rather than using individual conforming reinforcing sheets as in FIGS. 9 and 10, composite panel 200 has a single dimpled panel 212 bonded to surface regions 116A and recesses 118 of core 116. That is, dimpled panel 212 is a contiguous panel having dimpled regions 214 coupled together by surface regions 216. Each dimpled region's convex surface 214A conforms to and is bonded to core 116 at a recess 118, and each dimpled region's concave surface 214B defines a smaller-sized recess 118A. Dimpled panel 212 can integrate the recess reinforcement function of the present invention by, for example, incorporating fibers (not shown) in at least dimpled regions 214 of panel 212. Panel 212 could be formed (e.g., laid up, molded, etc.) directly onto core 116 so that it will bond to core 116 as it cures. Suitable materials for dimpled panel 212 include carbon-fiber composites, fiberglass, aluminum, or any other material that can be molded, machined or stamped to fit the shape.

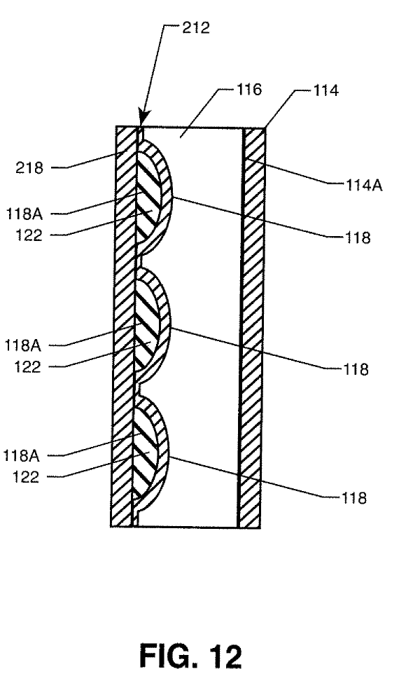

Similar to the above-described composite panel 100, there may be applications for composite panel 200 that would subject the panel to load-induced vibrations resulting in panel-generated noise. Accordingly, vibration damping material 122 can be disposed partially or fully in recesses 118A formed by dimpled panel 212 as shown in FIG. 12. If necessary, vibration damping material 122 can be protected by individual covers (not shown) mounted on dimpled panel 212 or by a contiguous cover sheet 218 that spans the entirety of dimpled panel 212.

The advantages of the present invention are numerous. Composite panels with recesses formed therein for noise control have the recesses reinforced to provide increased panel stiffness. Since the recess reinforcement retains the character of the recesses, the noise control attributes provided by the recesses are substantially maintained. Composite panels constructed in accordance with the present invention can be used in a variety of load-carrying applications that must also limit noise transmission and be lightweight.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, means-plus-function and step-plus-function clauses are intended to cover the structures or acts described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed as new and desired to be secured by Letters Patent of the United States is:

1. A composite panel, comprising:
a core having first and second opposing sides with at least one recess formed in said core on at least one of said first and second opposing sides;
reinforcing means conforming to each of said at least one recess and coupled to said core thereat, wherein reduced-sized recesses are defined by said reinforcing means; and
first and second facing sheets respectively coupled to said first and second opposing sides of said core.

2. A composite panel as in claim 1 further comprising at least one of acoustic damping material and vibration damping material disposed in at least one of said reduced-size recesses.

3. A composite panel as in claim 1 further comprising at least one of acoustic damping material and vibration damping material filling at least one of said reduced-size recesses.

4. A composite panel as in claim 1 wherein said core is a honeycomb core.

5. A composite panel as in claim 1 wherein said reinforcing means is integrated with at least one of said first facing sheet and said second facing sheet.

6. A composite panel as in claim 1 wherein said first and second facing sheets are one of the same material or different materials.

7. A composite panel as in claim 1 wherein said at least one recess comprises smoothly contoured recesses.

8. A composite panel as in claim 1 wherein transverse wave speed of each of said first and second facing sheets is subsonic.

9. A composite panel as in claim 1 wherein said at least one recess is formed on said first and second opposing sides of said core in a mirror image fashion.

10. A composite panel as in claim 1 wherein said at least one recess is formed on said first and second opposing sides of said core in a non-mirror image fashion.

11. A composite panel as in claim 1 wherein each of said at least one recess is identically sized and shaped.

12. A composite panel, comprising:
a core having first and second opposing sides with at least one recess formed in said core on at least one of said first and second opposing sides;
a sheet of reinforcing material conforming to each of said at least one recess and bonded on a first face thereof to said core and having a second face thereof defining a depression corresponding in shape to a corresponding one of said at least one recess; and
first and second facing sheets respectively coupled to said first and second opposing sides of said core.

13. A composite panel as in claim 12 further comprising at least one of acoustic damping material and vibration damping material disposed in at least one of said depressions.

14. A composite panel as in claim 12 further comprising at least one of acoustic damping material and vibration damping material filling each said depressions.

15. A composite panel as in claim 12 wherein said core is a honeycomb core.

16. A composite panel as in claim 12 wherein each said sheet of reinforcing material is integrated with one of said first facing sheet and said second facing sheet.

17. A composite panel as in claim 12 wherein said first and second sheets are one of the same material or different materials.

18. A composite panel as in claim 12 wherein said at least one recess comprises smoothly contoured recesses.

19. A composite panel as in claim 12 wherein transverse wave speed of each of said first and second facing sheets is subsonic.

20. A composite panel as in claim 12 wherein said at least one recess is formed on said first and second opposing sides of said core in a mirror image fashion.

21. A composite panel as in claim 12 wherein said at least one recess is formed on said first and second opposing sides of said core in a non-mirror image fashion.

22. A composite panel as in claim 12 wherein each of said at least one recess is identically sized and shaped.

23. A composite panel, comprising:
a honeycomb core having first and second opposing sides with at least one recess formed in said core on at least one of said first and second opposing sides;
reinforcing means conforming to each of said at least one recess and coupled to said core thereat, wherein reduced-sized recesses are defined by said reinforcing means;
first and second facing sheets respectively coupled to said first and second opposing sides of said core; and
at least one of acoustic damping material and vibration damping material disposed in at least one of said reduced-size recesses.

24. A composite panel as in claim 23 wherein said reinforcing means is integrated with at least one of said first facing sheet and said second facing sheet.

25. A composite panel as in claim 23 wherein said at least one recess is formed on said first and second opposing sides of said core in a non-mirror image fashion.
